(19) United States
(12) Patent Application Publication
(10) Pub. No.: US 2025/0032933 A1
(43) Pub. Date: Jan. 30, 2025

(54) LOADING STATE DETECTION FOR GAMING APPLICATIONS

(71) Applicant: Google LLC, Mountain View, CA (US)

(72) Inventors: Katie Leah Roberts-Hoffman, Mountain View, CA (US); Jaking Kong, San Jose, CA (US)

(21) Appl. No.: 18/715,461

(22) PCT Filed: Dec. 17, 2021
(86) PCT No.: PCT/US2021/064118

§ 371 Date: May 31, 2024

(51) Int. Cl. A63F 13/77; A63F 13/45

(52) U.S. Cl. CPC A63F 13/77; A63F 13/45; A63F 2300/60

(57) ABSTRACT

A computing device may determine one or more characteristics of a gaming application executing at one or more processors of the computing device. The computing device may determine that the gaming application executing at the one or more processors is in a loading state based at least in part on the one or more characteristics. The computing device may, in response to determining that the gaming application is in the loading state, adjust at least one of: a clock speed of the one or more processors or a prioritization of the gaming application.

### BACKGROUND

Before entering into a gaming session, a gaming application may enter a loading state to perform actions to prepare for the gaming session, such as loading assets and/or resources, setting up a multiplayer gaming session, and/or compiling shaders used by the gaming application during the gaming session. While the gaming application performs such actions to prepare for entering into a gaming session, the gaming application may output a loading screen to indicate to the user that the gaming application is in the loading state.

### SUMMARY

In general, techniques of this disclosure are directed to determining whether a gaming application executing at a computing device is in a loading state and, in response to determining that the gaming application is in the loading state, take one or more actions to decrease the amount of time the gaming application spends in the loading state. For example, the computing device may, in response to determining that the gaming application is in the loading state, increase the clock speeds of the one or more processors of the computing device and/or increase the priority of the gaming application, thereby enabling the computing device to reduce the amount of time it takes for the gaming application to perform actions to prepare for the gaming session, and thereby reducing the amount of time that the user of the gaming application may have to wait to start or resume their gaming session.

The computing device may determine whether the gaming application is in the loading state without receiving explicit indications of the state of the gaming application. Instead, the computing device may determine, based on one or more characteristics associated with the gaming application during execution, whether the gaming application is in the loading state, thereby enabling the computing device to improve the performance of gaming applications that do not explicitly indicate their states.

In one example, this disclosure describes a method that includes determining, by one or more processors of a computing device, one or more characteristics of a gaming application executing at the one or more processors; determining, by the one or more processors and based at least in part on the one or more characteristics, that the gaming application is in a loading state; and in response to determining that the gaming application is in the loading state, adjusting, by the one or more processors, at least one of: a clock speed of the one or more processors or a prioritization of the gaming application.

In another example, this disclosure describes a computing device that includes memory; and one or more processors operably coupled to the memory and configured to: determine one or more characteristics of a gaming application executing at the one or more processors; determine, based at least in part on the one or more characteristics, that the gaming application is in a loading state; and in response to determining that the gaming application is in the loading state, adjust at least one of: a clock speed of the one or more processors or a prioritization of the gaming application.

In another example, this disclosure describes a computer-readable storage medium storing instructions that, when executed, cause one or more processors of a computing device to: determine one or more characteristics of a gaming application executing at the one or more processors; determine, based at least in part on the one or more characteristics, that the gaming application is in a loading state; and in response to determining that the gaming application is in the loading state, adjust at least one of: a clock speed of the one or more processors or a prioritization of the gaming application.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example computing device that is configured to determine that a gaming application is in a loading state, in accordance with one or more aspects of the present disclosure

FIG. 2 is a block diagram illustrating an example computing device, in accordance with one or more aspects of the present disclosure.

FIG. 3 is a block diagram illustrating an example computing device that outputs graphical content for display at a remote device, in accordance with one or more techniques of the present disclosure.

FIG. 4 is a flowchart illustrating an example mode of operation for a computing device to determine whether a gaming application is in a loading state, in accordance with one or more techniques of the present disclosure.

### DETAILED DESCRIPTION

In general, techniques of this disclosure are directed to determining whether a gaming application executing at a computing device is in a loading state and, in response to determining that the gaming application is in the loading state, taking one or more actions to decrease the amount of time the gaming application spends in the loading state. The computing device may determine whether the gaming application is in the loading state without receiving explicit indications of the state of the gaming application. Instead, the computing device may determine, based on one or more characteristics associated with the gaming application during execution, whether the gaming application is in the loading state.

A gaming application may, during execution, transition between a plurality of states, such a gaming state a loading state, and a menu state. A gaming application may be in a gaming state when the gaming application is providing an interactive gameplay environment for active gameplay by the user of the computing device, also referred to herein as a gaming session. The gaming application may be in a menu state when the gaming application is outputting a menu screen. The gaming application may be in a loading state when the gaming application is performing operations in preparation for entering a gaming session, such as loading assets and/or resources for the game, loading and/or compiling shaders to be used during the game, setting up a multiplayer gaming session, and the like. In some examples, the gaming application may be in a waiting state when the player is in a lobby or a waiting room.

When a gaming application is in the loading state to perform operations for entering a gaming session, the user of the gaming application may be forced to sit and wait for the gaming session to begin so that the user may start or resume their gameplay. As such, being able to reduce the duration in which the gaming application is in a loading state may provide a better user experience by enabling the user to more quickly start playing the gaming application.

In accordance with aspects of the present disclosure, a computing device may, during execution of a gaming application, determine whether the gaming application is in a loading state and may, in response to determining that the gaming application is in the loading state, take one or more actions to decrease the amount of time the gaming application spends in the loading state. For example, the computing device may, in response to determining that the gaming application is in the loading state, increase the clock speeds of the one or more processors of the computing device and/or increase the priority of the gaming application, thereby enabling the computing device to reduce the amount of time it takes for the gaming application to perform actions to prepare for the gaming session.

The computing device may be able to determine whether the gaming application is in the loading state without receiving, from the gaming application, explicit indications of the gaming application being in the loading state. Instead, the computing device may be able to determine whether the gaming application is in the loading state based on one or more characteristics associated with the gaming application during execution, such as the pattern of user inputs received during execution of the gaming application, the patterns of usage of the one or more processors of the computing device, the functions issued by the gaming application during execution, the image data being outputted by the gaming application during execution, and the like.

The techniques of this disclosure may provide one or more technical advantages. For example, by determining whether the gaming application is in the loading state and increasing the clock speeds of the one or more processors when the gaming application is in the loading states, the techniques of this disclosure enable the computing device to adaptively adjust the clock speeds of the one or more processors based on the state of the gaming application, thereby enabling the computing device to increase the clock speeds of the one or more processors when the increased clock speeds may be necessary for performing performance-critical tasks while decreasing the clock speeds of the one or more processors when a higher clock speed may not be necessary.

Enabling the computing device to adaptively adjust the clock speeds of the one or more processors based on the state of the gaming application may therefore enable the computing device to reduce battery drain during execution of the gaming application by refraining from always operating the one or more processors at the highest possible clock speeds. Reducing the battery drain of the computing device may, in cases where the computing device is a mobile computing device, increase the battery life of the computing device.

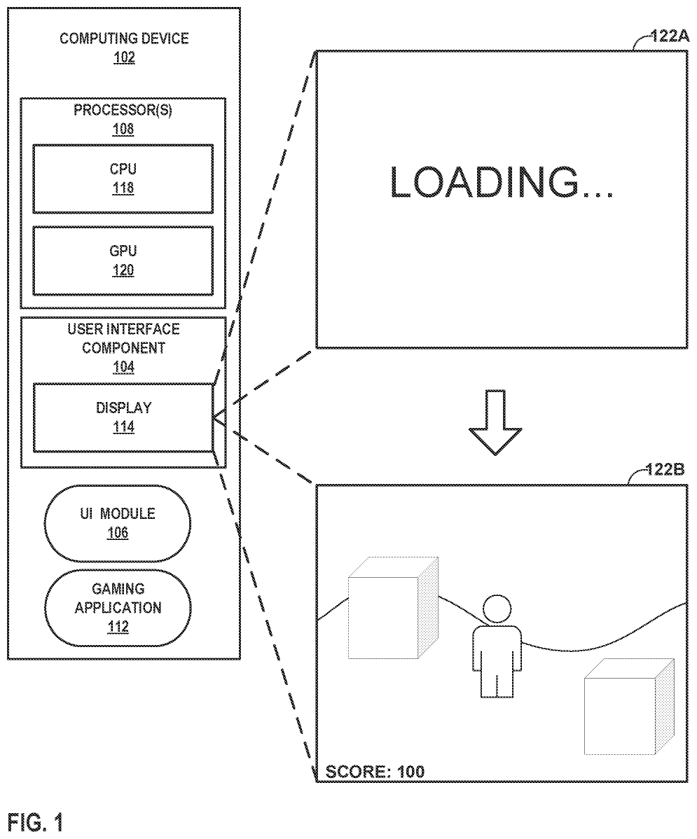

FIG. 1 is a conceptual diagram illustrating an example computing device that is configured to determine that a gaming application is in a loading state, in accordance with one or more aspects of the present disclosure. In the example of FIG. 1, computing device 102 may include, but is not limited to, portable or mobile devices such as mobile phones (including smart phones), laptop computers, tablet computers, wearable computing devices such as smart watches or computerized eyewear, smart television platforms, cameras, personal digital assistants (PDAs), etc. In some examples, computing device 102 may include stationary computing devices such as desktop computers, servers, mainframes, etc.

As shown in FIG. 1, computing device 102 includes user interface component 104 (“UIC 104”) user interface module 106 (“UI module 106”), and gaming application 112. UI module 106 and gaming application 112 may perform operations described herein using software, hardware, firmware, or a mixture of both hardware, software, and firmware residing in and executing on computing device 102 or at one or more other remote computing devices. In some examples, UI module 106 and gaming application 112 may be implemented as hardware, software, and/or a combination of hardware and software. Computing device 102 may execute module 106 and gaming application 112 with one or more processors 108. Computing device 102 may execute any of module 106 and gaming application 112 as or within a virtual machine executing on underlying hardware. UT module 106 and gaming application 112 may be implemented in various ways. For example, any of module 106 and/or gaming application 112 may be implemented as a downloadable or pre-installed application or “app.” In another example, any of module 106 and gaming application 112 may be implemented as part of an operating system of computing device 102. Other examples of computing device 102 that implement techniques of this disclosure may include additional components not shown in FIG. 1.

One or more processors 108 may implement functionality and/or execute instructions within computing device 102. For example, one or more processors 108 may receive and execute instructions that provide the functionality of UI module 106 and gaming application 112 to perform one or more operations. That is, UI module 106 and gaming application 112 may be operable by processors 40 to perform various functions described herein. In the example of FIG. 1, one or more processors include central processing unit (CPU) 118 and graphics processing unit (GPU) 120. GPU 120 may be a processing unit configured to configured to perform graphics related functions, such as to generate and output graphics data for presentation on a display, as well as to perform non-graphics related functions that exploit the massive processing parallelism provided by GPU 120. Examples of CPU 118 and GPU 120 include, but are not limited to, a digital signal processor (DSP), a general purpose microprocessor, application specific integrated circuit (ASIC), field programmable logic array (FPGA), or other equivalent integrated or discrete logic circuitry.

UIC 104 of computing device 102 may function as an input device for computing device 102 and as an output device. For instance, UIC 104 may function as an input device using a resistive touchscreen, a surface acoustic wave touchscreen, a capacitive touchscreen, a projective capacitance touchscreen, a pressure sensitive screen, an acoustic pulse recognition touchscreen, or another presence-sensitive screen technology. UIC 104 may function as an output device using any one or more of a liquid crystal display (LCD), dot matrix display, light emitting diode (LED) display, microLED, miniLED, organic light-emitting diode (OLED) display, e-ink, or similar monochrome or color display capable of outputting visible information to the user of computing device 102. For example, UIC 104 includes display 114.

In some examples, display 114 may be a presence-sensitive screen that may receive tactile user input from a user of computing device 102. UIC 104 may receive the tactile user input by detecting one or more taps and/or gestures from a user of computing device 102 (e.g., the user touching or pointing to one or more locations of UIC 104 with a finger or a stylus pen). The presence-sensitive screen of UIC 104 may present output to a user. UIC 104 may present the output as a user interface, which may be related to functionality provided by computing device 102. For example, UIC 104 may present various functions and applications executing on computing device 102 such as an electronic message application, a messaging application, a map application, etc.

UI module 106 may be implemented in various ways. For example, UI module 106 may be implemented as a downloadable or pre-installed application or “app.” In another example, UI module 106 may be implemented as part of a hardware unit of computing device 102. In another example, UI module 106 may be implemented as part of an operating system of computing device 102. In some instances, portions of the functionality of UI module 106 or any other module described in this disclosure may be implemented across any combination of an application, hardware unit, and operating system.

UI module 106 may interpret inputs detected at UIC 104 (e.g., as a user provides one or more gestures at a location of UIC 104 at which user interface 14A or another example user interface is displayed). UI module 106 may relay information about the inputs detected at UIC 104 to one or more associated platforms, operating systems, applications, and/or services executing at computing device 102 to cause computing device 102 to perform a function. UI module 106 may also receive information and instructions from one or more associated platforms, operating systems, applications, and/or services executing at computing device 102 (e.g., gaming application 112) for generating a graphical user interface (GUI). In addition, UI module 106 may act as an intermediary between the one or more associated platforms, operating systems, applications, and/or services executing at computing device 102 and various output devices of computing device 102 (e.g., speakers, LED indicators, vibrators, etc.) to produce output (e.g., graphical, audible, tactile, etc.) with computing device 102.

In the example of FIG. 1, computing device 102 includes gaming application 112 that executes at one or more processors 108 to perform the functionality of a video game. Although shown as operable by computing device 102, gaming application 112 may, in some examples, be operable by a remote computing device that is communicatively coupled to computing device 102. In such examples, a gaming application executing at a remote computing device may cause the remote computing device to send the content and intent information using any suitable form of data communication (e.g., wired or wireless network, short-range wireless communication such as Near Field Communication or Bluetooth, etc.). In some examples, a remote computing device may be a computing device that is separate from computing device 102.

As gaming application 112 executes at one or more processors 108, gaming application 112 may be in one of a plurality of states, and gaming application 112 may transition between the plurality of states during execution at one or more processors 108. For example, gaming application 112 may be in one of: a gaming state, a menu state, or a loading state, and may transition between the different states during execution at one or more processors 108.

Gaming application 112 may be in a gaming state when gaming application 112 is providing an interactive gameplay environment for active gameplay by the user of computing device 102, such as a gaming session. That is, when gaming application 112 is in the gaming state, gaming application 112 enables the user of computing device 102 to actively provide user input at UIC 104 to play a game in the interactive gameplay environment, such as by providing user input at UIC 104 in an attempt to complete a level of the game, to achieve a high score, to beat a final boss, to beat an opponent at the game, to cooperate with other players to complete a goal (e.g., a quest), to simulate operating a motor vehicle, and the like.

When gaming application 112 is not providing an interactive gameplay environment for active gameplay by the user of the computing device, gaming application 112 may not be in the gaming state. For example, when gaming application 112 is outputting a menu screen of gaming application 112, gaming application 112 may be in a menu state. In another example, when gaming application 112 is performing actions in preparation for entering a gaming session, such as when gaming application 112 is loading assets and resources and/or compiling shaders to be used in the gaming session, gaming application 112 may be in a loading state. For example, when the user of gaming application 112 finishes a level of the game, gaming application 112 may transition from the gaming state to the loading state so that gaming application 112 may perform actions in preparation for loading the next level of the game. In another example, when the user of gaming application 112 starts or resumes a game, gaming application 112 may enter the loading state to perform actions in preparation for loading the game. In general, gaming application 112 may transition from the loading state to the gaming state once gaming application 112 has finished performing actions to prepare for entering the gaming session.

Gaming application 112 may not explicitly indicate the current state of gaming application 112 to the operating system of computing device 102, and gaming application 112 may not explicitly indicate that gaming application 112 has exited a state and entered a different state. That is, when gaming application 112 is in the loading state, gaming application 112 may not provide an explicit indication that gaming application 112 is in the loading state to the operating system of computing device 102. Similarly, when gaming application 112 is in a gaming state, gaming application 112 may not provide an explicit indication that gaming application 112 is in the gaming state to the operating system of computing device 102.

As such, in accordance with aspects of the present disclosure, computing device 102 may determine the current state of gaming application 112 without receiving, from gaming application 112, explicit indications of the current state of gaming application 112. Instead, as gaming application 112 executes at one or more processors 108, computing device 102 may determine one or more characteristics associated with gaming application 112 and may determine the current state of gaming application 112 based at least in part on the one or more characteristics. Computing device 102 may, in response to determining that gaming application 112 is in the loading state, take one or more actions, without user intervention, to reduce the amount of time gaming application 112 spends in the loading state, such as by increasing the clock speeds of CPU 118 and/or GPU 120 and/or by increasing the execution priority of gaming application 112 in computing device 102.

The one or more characteristics associated with gaming application 112 executing at one or more processors 108 may include any characteristics and/or behaviors of computing device 102 that are caused by or otherwise associated with gaming application 112 executing at one or more processors 108 other than explicit indications of the state of gaming application 112 received from gaming application 112. Specifically, the one or more characteristics may include characteristics of components of computing device 102 that are indicative of differences in behavior of gaming application 112 and/or computing device 102 while gaming application 112 is in the loading state compared with gaming application 112 in other states.

In some examples, the one or more characteristics may include one or more of: patterns of usage of one or more processors 108 by gaming application 112 during execution, the functions invoked by gaming application 112 and being executed by one or more processors 108 during execution of gaming application 112, the characteristics of the image data outputted for display at display 114 by gaming application 112 during execution, system log output of gaming application 112 during execution, the name of gaming application 112, and the like. Computing device 102 may determine, based at least in part on the one or more characteristics associated with gaming application 112, whether gaming application 112 is in a loading state. As discussed above, computing device 102 may determine whether gaming application 112 is in a loading state without the operating system of computing device 102 receiving, from gaming application 112, explicit indications of gaming application 112 being in a loading state.

Computing device 102 may use any suitable technique to determine, based on the one or more characteristics associated with gaming application 112, whether gaming application 112 is in a loading state. In some examples, if at least one of the one or more characteristics associated with gaming application 112 indicates that gaming application 112 is in the loading state, then computing device 102 may determine that gaming application 112 is in the loading state. In some examples, if a majority of the one or more characteristics associated with gaming application 112 indicates that gaming application 112 is in the loading state, then computing device 102 may determine that gaming application 112 is in the loading state.

In some examples, computing device 102 may implement and use one or more neural networks trained via machine learning to determine, based on the one or more characteristics associated with gaming application 112 whether gaming application 112 is in a loading state. In general, one or more neural networks implemented by computing device 102 may include multiple interconnected nodes, and each node may apply one or more functions to a set of input values that correspond to one or more features, and provide one or more corresponding output values. The one or more features may be the one or more characteristics associated with gaming application 112, and the one or more corresponding output values of one or more neural networks may be an indication of whether gaming application 112 is in a loading state.

The one or more corresponding output values may, in some examples, include probabilities of gaming application 112 being in the loading state. Accordingly, computing device 102 may use one or more neural networks to determine probabilities of gaming application 112 being in each of a plurality of states. Computing device 102 may therefore determine that gaming application 112 is in a loading state if the probability of gaming application 112 being in a loading state is greater than the probability of gaming application 112 being in any other state.

In some examples, the one or more corresponding output values may include a confidence score associated with each of the states of gaming applications 112. Accordingly, computing device 102 may use one or more neural networks to determine a respective confidence score of gaming application 112 being in each of a plurality of states based on the one or more characteristics. Computing device 102 may therefore determine that gaming application 112 is in a loading state if the confidence score of gaming application 112 being in a loading state is greater than the confidence scores of gaming application 112 being in any other state.

Computing device 102 may, in response to determining that gaming application 112 is in the loading state, adjust at least one of: a clock speed of one or more processors 108 or a prioritization of gaming application 112. For example, computing device 102 may, in response to determining that gaming application 112 is in the loading state, adjust the clock speed of CPU 118 and/or the clock speed of GPU 120, such as by increasing the clock speed of CPU 118 and/or the clock speed of GPU 120 to increase the amount of instructions of gaming application 112 that can be executed by CPU 118 and/or GPU 120 and to reduce the amount of time gaming application 112 remains in the loading state prior to transitioning to the gaming state.

In some examples, computing device 102 may, in response to determining that gaming application 112 is in the loading state, increase the execution priority of gaming application 112. That is, computing device 102 may prioritize the execution of instructions of gaming application 112 by one or more processors 108 over the execution of other processes that are also executing at one or more processors 108. Increasing the prioritization of gaming application 112 may increase the amount of instructions of gaming application 112 executed by one or more processors 108 in a given time period, thereby enabling computing device 102 to reduce the amount of time gaming application 112 remains in the loading state prior to transitioning to the gaming state.

In the example of FIG. 1, while gaming application 112 is in a loading state, gaming application 112 may output GUI 122A of a loading screen. While gaming application 112 is in the loading state, computing device 102 may continuously determine one or more characteristics associated with gaming application 112 executing at one or more processors 108, and may determine, based on the one or more characteristics associated with gaming application 112 executing at one or more processors 108, that gaming application 112 is in the loading state. Computing device 102 may therefore adjust at least one of: a clock speed of one or more processors 108 or a prioritization of gaming application 112 in order to decrease the amount of time that gaming application 112 remains in the loading state. Gaming application 112 may transition from the loading state to the gaming state. Gaming application 112 may, during the transition to or after transitioning to the gaming state, output GUI 122B of an interactive gameplay environment for active gameplay by the user of computing device 102.

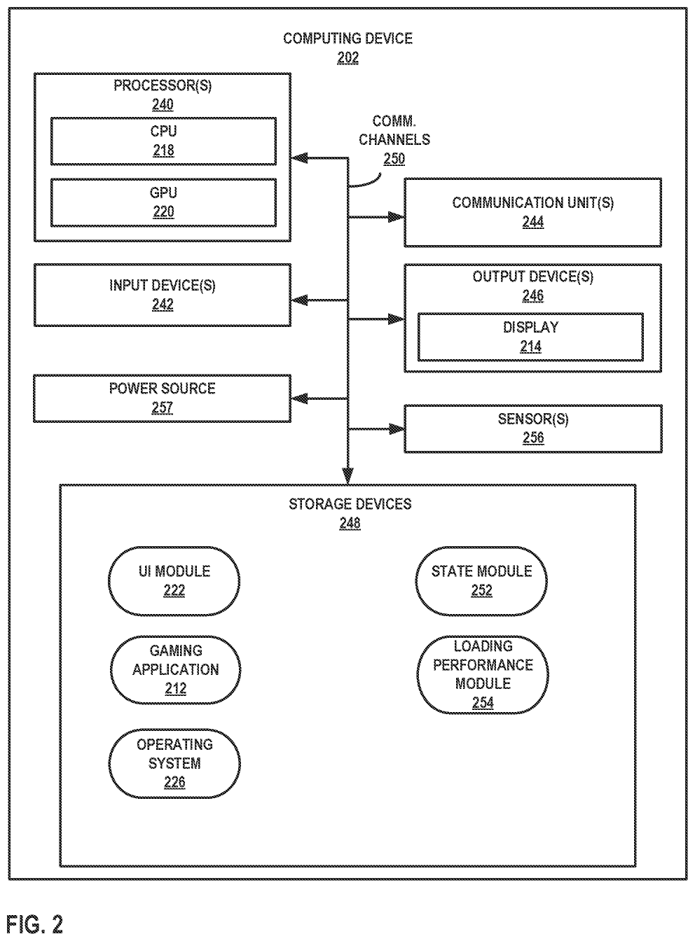

FIG. 2 is a block diagram illustrating an example computing device, in accordance with one or more aspects of the present disclosure. FIG. 2 illustrates only one particular example of computing device 102, and many other examples of computing device 102 may be used in other instances and may include a subset of the components included in example computing device 102 or may include additional components not shown in FIG. 2.

As shown in the example of FIG. 2, computing device 202 includes one or more processors 240, one or more input devices 242, one or more communication units 244, one or more output devices 246, one or more storage devices 248, and one or more sensors 256. One or more processors 240 may be an example of one or more processors 108 of FIG. 1. One or more input devices 242 and one or more output device 246 may be examples of UIC 104 of FIG. 1. Storage devices 248 of computing device 202 also include UI module 222, gaming application 212, operating system 226, state module 252, and loading performance module 254. Communication channels 250 may interconnect each of the components 240, 242, 244, 246, 248, and 256 for inter-component communications (physically, communicatively, and/or operatively). In some examples, communication channels 250 may include a system bus, a network connection, one or more inter-process communication data structures, or any other components for communicating data between hardware and/or software.

One or more processors 240 may implement functionality and/or execute instructions within computing device 202. For example, processors 240 on computing device 102 may receive and execute instructions stored by storage devices 248 that provide the functionality of UI module 222, gaming application 212, operating system 226, state module 252, and loading performance module 254. These instructions executed by processors 240 may cause computing device 202 to store and/or modify information, within storage devices 48 during program execution. Processors 240 may execute instructions of UI module 222, gaming application 212, operating system 226, state module 252, and loading performance module 254. That is, UI module 222, gaming application 212, operating system 226, state module 252, and loading performance module 254 may be operable by processors 240 to perform various functions described herein.

One or more processors 240 may include CPU 218 and GPU 220. GPU 220 may be a processing unit configured to configured to perform graphics related functions, such as to generate and output graphics data for presentation on a display, as well as to perform non-graphics related functions that exploit the massive processing parallelism provided by GPU 220. Examples of CPU 218 and GPU 220 include, but are not limited to, a digital signal processor (DSP), a general purpose microprocessor, application specific integrated circuit (ASIC), field programmable logic array (FPGA), or other equivalent integrated or discrete logic circuitry.

One or more input devices 242 of computing device 202 may receive input. Examples of input are tactile, audio, kinetic, and optical input, to name only a few examples. Input devices 242 of computing device 202, in one example, include a mouse, keyboard, voice responsive system, video camera, buttons, control pad, microphone or any other type of device for detecting input from a human or machine. In some examples, input device 242 may be a presence-sensitive input device, which may include a presence-sensitive screen, touch-sensitive screen, etc.

One or more output devices 246 of computing device 102 may generate output. Examples of output are tactile, audio, and video output. Output devices 246 of computing device 202, in one example, include a presence-sensitive screen, such as display 214, sound card, video graphics adapter card, speaker, or any other type of device for generating tactile, audio, and/or visual output. Display 214 may use any one or more of a liquid crystal display (LCD), dot matrix display, light emitting diode (LED) display, microLED, miniLED, organic light-emitting diode (OLED) display, e-ink, or similar monochrome or color display capable of outputting visible information to the user of computing device 202.

One or more communication units 244 of computing device 202 may communicate with external devices by transmitting and/or receiving data. For example, computing device 202 may use communication units 244 to transmit and/or receive radio signals on a radio network such as a cellular radio network. In some examples, communication units 244 may transmit and/or receive satellite signals on a satellite network such as a Global Positioning System (GPS) network. Examples of communication units 244 include a network interface card (e.g., an Ethernet card), an optical transceiver, a radio frequency transceiver, a GPS receiver, or any other type of device that can send and/or receive information. Other examples of communication units 44 may include Bluetooth®, GPS, 3G, 4G, and Wi-Fi® radios found in mobile devices as well as Universal Serial Bus (USB) controllers and the like.

One or more storage devices 248 within computing device 202 may store information for processing during operation of computing device 202. In some examples, storage device 248 is a temporary memory, meaning that a primary purpose of storage device 248 is not long-term storage. Storage devices 248 on computing device 202 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art.

Storage devices 248, in some examples, also include one or more computer-readable storage media. Storage devices 248 may be configured to store larger amounts of information than volatile memory. Storage devices 248 may further be configured for long-term storage of information as non-volatile memory space and retain information after activate/off cycles. Examples of non-volatile memories include magnetic hard discs, optical discs, floppy discs, flash memories, or forms of electrically programmable memories (EPROM) or electrically erasable and programmable (EEPROM) memories. Storage devices 248 may store program instructions and/or data associated with UI module 222, which may be an example of UI module 106 of FIG. 1, gaming application 212, which may be an example of gaming application 112 of FIG. 1, operating system 226, state module 252, and loading performance module 254.

As shown in FIG. 2, computing device 202 may include one or more sensors 256. Sensors 256 may include an accelerometer that generates accelerometer data. Accelerometer data may indicate an acceleration and/or a change in acceleration of computing device 202. Sensors 256 may include a gyroscope that generates gyroscope data. Gyroscope data may indicate a physical orientation and/or change in physical orientation of computing device 102. In some examples, the orientation may be relative to one or more reference points. Sensors 256 may include a magnetometer that generates magnetometer data. Magnetometer data may indicate the magnetization of an object that is touching or in proximity to computing device 202. Magnetometer data may indicate the Earth's magnetic field, and in some examples, provide directional functionality of a compass. Sensors 256 may include an ambient light sensor that generates ambient light data. The ambient light data may indicate an intensity of light to which computing device 202 is exposed. Sensors 256 may include a proximity sensor that generates proximity data. Proximity data may indicate whether an object is within proximity to computing device 202. In some examples, proximity data may indicate how close an object is to computing device 202. In some examples, sensors 256 may include a clock that generates a date and time. The date and time may be a current date and time.

As shown in FIG. 2, computing device 202 may include a power source 257 In some examples, power source 257 may be a battery. Power source 257 may provide power to one or more components of computing device 202. Examples of power source 257 may include, but are not necessarily limited to, batteries having zinc-carbon, lead-acid, nickel cadmium (NiCd), nickel metal hydride (NiMH), lithium ion (Li-ion), and/or lithium ion polymer (Li-ion polymer) chemistries. In some examples, power source 257 may have a limited capacity (e.g., 1000-4000 mAh).

In accordance with techniques of the disclosure, one or more processors 240 of computing device 202 are configured to execute state module 252 to determine the state of gaming application 212 as gaming application 212 executes at one or more processors 240. As gaming application 212 executes at one or more processors 240, gaming application 212 may be in one of a plurality of states, including a gaming state, a loading state, a menu state, and the like.

State module 252 may be able to determine the current state of gaming application 212 without receiving, from gaming application 212, an explicit indication of the state of gaming application 212. Instead, state module 252 may determine the state of gaming application 212 as gaming application 212 executes at one or more processors 240 based on one or more characteristics associated with gaming application 212 executing at one or more processors 240. One or more processors 240 may periodically execute state module 252 to determine the current state of gaming application 212 as gaming application 212 executes at one or more processors 240. For example, one or more processors 240 may execute state module 252 to determine the current state of gaming application 212 once a second, five times a second, ten times a second, and the like.

Gaming application 212 executes at one or more processors 240 to perform the functionality of a video game. In some examples, gaming application 212 may be an action game that may emphasize hand-eye coordination and reaction time, such as a first-person shooter game, a battle royale game, etc. In some examples, gaming application 212 may be a simulation game, such as a motorsports simulation game, an airplane simulation game, a trucking simulation game, and the like. In other examples, gaming application 212 may be a role playing game (e.g., a massive multiplayer role playing game), a networked multi-player game, a single player game, and the like.

As gaming application 212 executes at one or more processors 240, gaming application 212 may output image data for display at display 214. Image data, in some examples, may be frames of graphics that gaming application 212 outputs for display at display 214 during execution of gaming application 212. For example, the image data may include frames of graphics of the interactive gameplay environment, frames of graphics of loading screens, frames of graphics of menu screens, and the like.

As gaming application 212 executes at one or more processors 240, gaming application 212 may be in one of a plurality of states, and gaming application 212 may transition between the plurality of states during execution at one or more processors 240. Specifically, gaming application 212 may be in one of: a gaming state or a non-gaming state, and may transition between the gaming state and the non-gaming state during execution at one or more processors 240.

Gaming application 212 may be in a gaming state when gaming application 212 is providing an interactive gameplay environment for active gameplay by the user of computing device 202. That is, when gaming application 212 is in the gaming state, gaming application 212 enables the user of computing device 202 to actively provide user input at one or more input devices 242 to play a game in the interactive gameplay environment, such as by providing user input at one or more input devices 242 in an attempt to complete a level of the game, to achieve a high score, to beat a final boss, to beat an opponent at the game, to cooperate with other players to complete a goal (e.g., a quest), to simulate operating a motor vehicle, and the like.

Gaming application 212 may be in a loading state when the gaming application is performing operations in preparation for entering a gaming session, such as loading assets and/or resources for the game, loading and/or compiling shaders to be used during the game, setting up a multiplayer gaming session, and the like. For example, when the user of gaming application 212 finishes a level of the game, gaming application 212 may transition from the gaming state to the loading state so that gaming application 212 may perform actions in preparation for loading the next level of the game. In another example, when the user of gaming application 212 starts or resumes a game, gaming application 212 may enter the loading state to perform actions in preparation for loading the game. In general, gaming application 212 may transition from the loading state to the gaming state once gaming application 212 has finished performing actions to prepare for entering the gaming session.

The one or more characteristics associated with gaming application 212 executing at one or more processors 240 may include any characteristics and/or behaviors of the components of computing device 202 and/or gaming application 212 that may be indicative of differences in the behavior of gaming application 212 and/or differences in the behavior of components of computing device 202 while gaming application 212 is in different states.

In some examples, the one or more characteristics may include patterns of usage of one or more processors 240 by gaming application 212 during execution, such as patterns of usage of CPU 218 and GPU 220 by gaming application 212. The usage of CPU 218 and GPU 220, such as the types of instructions executed by CPU 218 and/or GPU 220, the amount of instructions of gaming application 212 executed by CPU 218 and/or GPU 220, and the like, may be different when gaming application 212 is in a loading state compared with gaming application 212 being in another state.

When gaming application 212 is in the loading state, gaming application 212 may be performing actions to prepare gaming application 212 to provide an interactive gameplay environment for active gameplay by entering the gaming state (e.g., start a new game, start a new level of the game, resume the game from the last save location, etc.), such as loading assets for the game, making network calls to setup a multiplayer gaming session, and/or compiling shaders for rendering graphics when gaming application 212 is in the gaming state. While gaming application 212 may use GPU 220 to compile shaders, gaming application 212 may use CPU 218 to perform other actions, such as loading assets for the game, setting up a multiplayer gaming session, and the like.

As such, when gaming application 212 is in the loading state, gaming application 212 may more heavily utilize CPU 218 compared to GPU 220. That is, when gaming application 212 is in the loading state, gaming application 212 may call a greater number of functions that are executed by CPU 218 compared with functions that are executed by GPU 220, thereby increasing usage of CPU 218 compared with GPU 220. Further, when gaming application 212 is in the loading state, gaming application 212 may more heavily utilize CPU 218 compared to when gaming application 212 is in the gaming state, and gaming application 212 may, when in the loading state, utilize GPU 220 less heavily compared to when gaming application 212 is in the gaming state.

In some examples, one or more processors 240 may determine the workload of CPU 218 and/or GPU 220 via use of hardware performance counters. Such hardware performance counters may, for each of CPU 218 and GPU 220, track information such as the number of cache misses, the number of instructions issued, the number of instructions executed, and the like. For example, if the number of instructions executed by CPU 218, as indicated by the values of the hardware performance counters of CPU 218 is much greater than the number of instructions executed by GPU 220, as indicated by the values of the hardware performance counters of GPU 220, the difference between the number of instructions executed by CPU 218 and GPU 220 may be indicative of gaming application 212 being in the loading state.

As such, the pattern of usage of one or more processors 240 by gaming application 212 during execution may be indicative of the state of gaming application 212. The patterns of usage of one or more processors 240 may include the amount of usage of CPU 218 and/or the amount of usage of GPU 220 during execution of gaming application 212, such as the values of the hardware performance counters of CPU 218 and GPU 220.

In some examples, the one or more characteristics may include the patterns of one or functions invoked by gaming application 212 during execution. When gaming application 212 is in the loading state, gaming application 212 call a relatively greater amount of initialization functions, network functions, and shader compilation functions in order to prepare for transitioning to the gaming state compared with gaming application 212 in a different non-loading state. As such, if the functions called by gaming application 212 predominantly includes initialization functions, network functions, and shader compilation functions, such a pattern of functions invoked by gaming application 212 may be indicative of gaming application 212 being in the loading state. Thus, the pattern of one or more functions invoked by gaming application 212 included in the one or more characteristics may include the pattern of functions invoked by gaming application 212, the types of functions invoked by gaming application 212, and the like.

In some examples, the one or more characteristics may include the patterns of network usage by gaming application 212 during execution. When gaming application 212 is in the loading state, gaming application 212 may receive a relatively larger amount of data via the network, such as to receive assets via the network, but may transmit a relatively smaller amount of data via the network. As such, if the network usage gaming application 212 predominantly includes receiving data via a network, the network usage of gaming application 212 may be indicative of gaming application 212 being in the loading state.

In some examples, the one or more characteristics may include pattern of inputs received at one or more input devices 242 during execution of gaming application 212. Typically, a user using a gaming application may provide fewer input (e.g., no input) while the gaming application is in the loading state compared with while the gaming application is a gaming state or in a menu state. As such, computing device 202 may, during execution of gaming application 212, rarely receive user input at one or more input devices 242 while gaming application 212 is in the loading state compared with the frequency of user input received while gaming application 212 is in other states. Thus, the one or more characteristics may include indications of the frequency of user inputs received by computing device 202 during execution of gaming application 212.

In some examples, the pattern of inputs may also include the location of the input received at one or more input devices 242. For example, if the UI elements that correspond to controls of the gaming application 212 are outputted at known locations of a presence-sensitive display, inputs received at such locations of the UI elements that correspond to controls of the gaming application 212 may indicate that gaming application 212 is in a gameplay state, while inputs received outside of the locations of the UI elements that correspond to controls of the gaming application 212 may indicate that gaming application 212 is in a non-gameplay state

In some examples, the one or more characteristics may include image data outputted for display at display 214 by gaming application 212 during execution. When gaming application 212 is in the loading mode, the image data outputted by gaming application 212 for display at display 214 may be relatively stable. That is, when the gaming application 212 is in the loading state, gaming application 212 may refrain from frequently changing the image data outputted for display at display 214. Further, when gaming application 212 is in the loading mode, gaming application 212 may often output image data that is all in one color, such as black or white, for display at display 214. This is in contrast to when gaming application 212 is in the gaming state, where gaming application 212 may frequently change the image data outputted for display 214, and where gaming application 212 is more likely to output image data in a variety of different colors. Computing device 202 may be able to use the image data outputted for display at display 214 as part of the determination of whether gaming application 212 without recognizing any characters, words, or sentences that might be in the image data outputted for display, and without performing, for example, image recognition on the image data.

As such, the one or more characteristics may include indications of the amount of change between frames of image data outputted by gaming application 212. For example, state module 252 may determine, based on frames of image data outputted by gaming application 212, a histogram of image data, such as a histogram that counts the amount of times consecutive frames of image data outputted by gaming application 212 are unchanged and the amount of times consecutive frames of image data outputted by gaming application 212 are different. If the amount of times consecutive frames of image data outputted by gaming application 212 are unchanged exceeds a specified threshold, such a lack of change in the image data by gaming application 212 may be an indication that gaming application 212 is in the loading state.

In some examples, the one or more characteristics may include log output of gaming application 212 during execution of gaming application 212. As gaming application 212 executes, gaming application 212 may write information to one or more logs, such as to a system log. For example, when gaming application 212 enters and is in the loading state, gaming application may write, to one or more logs, an indication of gaming application 212 entering and/or being in the loading state. Furthermore, when gaming application 212 exits the loading state, gaming application 212 may write, to one or more logs, an indication of gaming application 212 exiting the loading state and/or an indication of gaming application 212 no longer being in the loading state.

In some examples, the one or more characteristics may include the name of gaming application 212. The name of gaming application 212 may be an application name, package name, executable name, and the like. Because a gaming application, such as gaming application 212, is likely to have the same or similar name across different devices, state module 252 may be able to determine, based on the name of gaming application 212, whether gaming application 212 is a gaming application that may be in a loading state. For example, state module 252 may be able to access a list of names of gaming applications, and state module 252 may determine whether the name of gaming application 212 matches one of the entries in the list of names of gaming applications. If state module 252 determines that the name of gaming application 212 matches one of the entries in the list of names of gaming applications, game play state module 252 may be able to determine, such as based on the other one or more characteristics associated with gaming application 212, whether gaming application 212 is in the loading state.

State module 252 may execute at one or more processors 240 to determine, based at least in part on the one or more characteristics associated with gaming application 212, whether gaming application 212 is in the loading state. As discussed above, state module 252 may determine whether gaming application 212 is in the loading state without receiving, such as from gaming application 212, explicit indications of gaming application 212 being or not being in the loading state.

State module 252 may use any suitable technique to determine, based on the one or more characteristics associated with gaming application 212, whether gaming application 212 is in a loading state. In some examples, if at least one of the one or more characteristics associated with gaming application 212 indicates that gaming application 212 is in the loading state, then state module 252 may determine that gaming application 212 is in the loading state. In some examples, if state module 252 determines that a majority of the one or more characteristics associated with gaming application 212 indicates that gaming application 212 is in the loading state, then state module 252 may determine that gaming application 212 is in the loading state.

In some examples, state module 252 may implement and use one or more neural networks trained via machine learning to determine, based on the one or more characteristics associated with gaming application 212 whether gaming application 212 is in the loading state. In general, one or more neural networks implemented by state module 252 may include multiple interconnected nodes, and each node may apply one or more functions to a set of input values that correspond to one or more features, and provide one or more corresponding output values. The one or more features may be the one or more characteristics associated with gaming application 212, and the one or more corresponding output values of one or more neural networks may be an indication of the state of gaming application 212.

In some examples, the one or more neural networks of state module 252 are trained to determine, based on one or more characteristics associated with a gaming application, the state of the gaming application. The one or more neural networks may perform such machine learning using training data that includes sets of characteristics associated with a state to learn connections between characteristics and states. In some examples, the one or more networks may be trained off-device (e.g., at an external computing system) and then installed and/or downloaded at computing device 202. In some examples, the one or more neural networks may be trained on-device at computing device 202.

The one or more corresponding output values may, in some examples, include probabilities of the gaming application 212 being in each of the plurality of states. Accordingly, state module 252 may implement one or more neural networks to determine probabilities of the state of gaming application 212 based on the one or more characteristics, and may determine and output an indication of the state of gaming application 212 having the highest probability of being the state of gaming application 212 based on the corresponding probabilities. If state module 252 determines that the loading state has the highest probability of being the state of gaming application 212, state module 252 may determine that gaming application 212 is in the loading state.

In some examples, the one or more corresponding output values of the one or more neural networks may include a respective confidence score for each of the plurality of states. Accordingly, state module 252 may implement one or more neural networks to determine a respective confidence score for gaming application 212 being in each of a plurality of states. As such, in some examples, state module 252 may determine the state of gaming application 212 to be the state associated with the highest confidence score. For example, if state module 252 determines that the loading state is associated with the highest confidence score, state module 252 may determine that gaming application 212 is in the loading state.

In some examples, state module 252 may use a combination of two or more models to determine, based on the one or more characteristics of gaming application 212 executing at one or more processors 240, the state of gaming application 212. For example, state module 252 may use a first model to determine, using a single characteristic, such as the name of gaming application 212, whether gaming application 212 is a gaming application. If state module 252 determines that gaming application 212 is a gaming application, state module 252 may use a second model that takes the additional one or more characteristics associated with gaming application 212 as input to output the probability and/or confidence of gaming application 212 being in the loading state. State module 252 may therefore determine, based on the output of the second model, the state of gaming application 212, such as whether gaming application 212 is in the gaming state. In some examples, the second model may be trained specifically for a particular gaming application, such as gaming application 212. A second model that is trained specifically for a particular gaming application may be trained using training data from execution of copies of the particular gaming application.

One or more processors 240 of computing device 202 are configured to execute loading performance module 254 to, in response to determining that gaming application 212 is in the loading state, adjust at least one of: a clock speed of one or more processors 208 or a prioritization of gaming application 212 in order to reduce the amount of time that gaming application 212 spends in the loading state. For example, loading performance module 254 may, in response to determining that gaming application 212 is in the loading state, adjust the clock speed of CPU 218 and/or the clock speed of GPU 220, such as by increasing the clock speed of CPU 218 and/or the clock speed of GPU 220. CPU 218 and/or GPU 220 may operate at the increased clock speeds until gaming application 212 is no longer in the loading state.

Loading performance module 254 may determine how much to increase the clock speeds of CPU 218 and/or GPU 220 when gaming application 212 is in the loading state. In some examples, loading performance module 254 may increase the clock speeds of CPU 218 and GPU 220 by different amounts when gaming application 212 is in the loading state, or may adjust the clock speeds of CPU 218 and/or GPU 220 so that CPU 218 and GPU 220 operate at different clock speeds when gaming application 212 is in the loading state. Loading performance module 254 may determine the respective workloads of CPU 218 and GPU 220 while gaming application 212 is in the loading state, and may adjust the clock speeds of CPU 218 and/or GPU 220 based on the respective workloads of CPU 218 and GPU 220 while gaming application 212 is in the loading state.

For example, if loading performance module 254 determines that the workload of CPU 218 is higher than the workload of GPU 220 while gaming application 212 is in the loading state, loading performance module 254 may, when gaming application 212 is in the loading state, increase the clock speed of CPU 218 by a greater amount than the increase the clock speed of GPU 220, set the clock speed of CPU 218 to a higher clock speed than the clock speed of GPU 220, or may increase the clock speed of CPU 218 while not increasing the clock speed of GPU 220. In another example, if loading performance module 254 determines that the workload of CPU 218 is lower than the workload of GPU 220 while gaming application 212 is in the loading state, loading performance module 254 may, when gaming application 212 is in the loading state, increase the clock speed of GPU 220 by a greater amount than the increase the clock speed of CPU 218, set the clock speed of GPU 220 to a higher clock speed than the clock speed of CPU 218, or may increase the clock speed of GPU 220 while not increasing the clock speed of CPU 218.

Loading performance module 254 may use hardware counters of CPU 218 and GPU 220 to determine the respective workloads of CPU 218 and GPU 220 while gaming application 212 is in the loading state. For example, as gaming application 212 executes while in the loading state, the hardware counters of CPU 218 and GPU 220 may count the number of instructions and/or functions executed by CPU 218 and GPU 220, respectively. Loading performance module 254 may therefore determine, based on the values of the hardware counters of CPU 218 and GPU 220, the respective workloads of CPU 218 and GPU 220 as gaming application 212 executes while in the loading state.

In some examples, loading performance module 254 may increase the clock speeds of CPU 218 and/or GPU 220 by setting the clock speed of CPU 218 and/or the clock speed of GPU 220 to the maximum clock speed allowed by computing device 202 for CPU 218 and/or GPU 220, respectively. In some examples, loading performance module 254 may, in response to determining that gaming application 212 is in the loading state, increase the clock speed of CPU 218 and/or the clock speed of GPU 220 to clock speeds that exceeds a clock speed threshold specified by computing device 202. For example, if computing device 202 is running on battery power, computing device 202 may set a maximum clock speed for CPU 218 and/or GPU 220 that may be less than the maximum clock speed for CPU 218 and/or GPU 220 when computing device 202 is connected to line power (e.g., when computing device 202 is plugged into a power outlet). Thus, in some examples, when computing device 202 is running on battery power, loading performance module 254 may, in response to determining that gaming application 212 is in the loading state, increase the clock speed of CPU 218 and/or the clock speed of GPU 220 to clock speeds that exceeds the maximum clock speed that is set by computing device 202 for when computing device 202 is running on battery power.

In some examples, loading performance module 254 may, in response to determining that gaming application 212 is in the loading state, determine whether to increase the clock speed of CPU 218 and/or the clock speed of GPU 220 and the amount by which to increase the clock speed of CPU 218 and/or the clock speed of GPU 220 based at least in part on the patterns of functions called by gaming application 212 in the loading state. For example, if the functions called by gaming application 212 in the loading state are predominantly functions that are to be executed by CPU 218, such as functions for loading assets, networking functions, and the like, loading performance module 254 may increase the clock speed of CPU 218. In another example, if the functions called by gaming application 212 in the loading state also include functions that are to be executed by GPU 220, such as shader compilation functions, loading performance module 254 may also increase the clock speed of GPU 220.

In some examples, different gaming applications may cause loading performance module 254, when the gaming applications are in the loading state, to increase clock speeds of CPU 218/GPU 220 to different clock speeds and/or cause loading performance module 254 to ramp the clock speeds of CPU 218/GPU 220 at different rates. In some examples, each of a plurality of different gaming applications may be associated with a loading state CPU clock speed and/or a loading state GPU clock speed. Thus, when gaming application 212 is in the loading state, loading performance module 254 may look up the loading state CPU clock speed and/or loading state GPU clock speed associated with gaming application 212. Loading performance module 254 may, when gaming application 212 enters the loading state, therefore set the clock speed of CPU 218 to the loading CPU clock speed associated with gaming application 212 and/or set the clock speed of GPU 220 to the loading GPU clock speed associated with gaming application 212.

The loading state CPU clock speed and/or loading state GPU clock speed associated with a gaming application may be determined by profiling execution of the gaming application. In the example of gaming application 212 executing at one or more processors 240, loading performance module 254 may, when gaming application 212 is in the loading state, vary the clock speeds of CPU 218 and/or GPU 220 as gaming application 212 executes and vary how fast the clock speeds of CPU 218 and/or GPU 220 are ramped up, to collect information, such as hardware counter values, regarding the execution of gaming application 212 in the loading state at different clock speeds of CPU 218 and/or GPU 220.

Loading performance module 254 may analyze the collected information, such as the hardware counter values, to determine the loading state CPU clock speed and/or loading state GPU clock speed associated with gaming application 212. For example, loading performance module 254 may determine that if the hardware counter values for CPU 218 does not vary between a maximum clock speed of CPU 218 and a lower clock speed of CPU 218, that loading performance module 254 may be able to set the clock speed for CPU 218 to the lower clock speed when gaming application 212 is in the loading state without losing performance and without otherwise increasing the amount of time gaming application 212 spends in the loading state.

In another example loading performance module 254 may determine that if the hardware counter values for CPU 218 does not vary between a faster ramp up of the clock speed of CPU 218 and a slower ramp up of the clock speed of CPU 218, that loading performance module 254 may be able to ramp the clock speed for CPU 218 at the slower ramp up rate when gaming application 212 is in the loading state without losing performance and without otherwise increasing the amount of time gaming application 212 spends in the loading state.

In another example, in addition to increasing the clock speed of CPU 218 and/or the clock speed of GPU 220, or as an alternative, loading performance module 254 may increase the prioritization of gaming application 212 by operating system 226. That is, if operating system 226 assigns a priority to each of the processes executing at one or more processors 240, operating system 226 may increase the priority of the one or more processes of gaming application 212. If operating system 226 schedules execution of processes based on the priority of each of the processes, increasing the priority of gaming application 212 may enable operating system 226 to schedule the execution of gaming application 212 before other, lower priority, processes, thereby enabling gaming application 212 to more quickly load assets and perform other actions to transition from the loading state to, for example, a gaming state. In some examples, instead or in additional to increasing the priority of gaming application 212, loading performance module 254 may decrease the priority of one or more other processes executing at one or more processors 240.

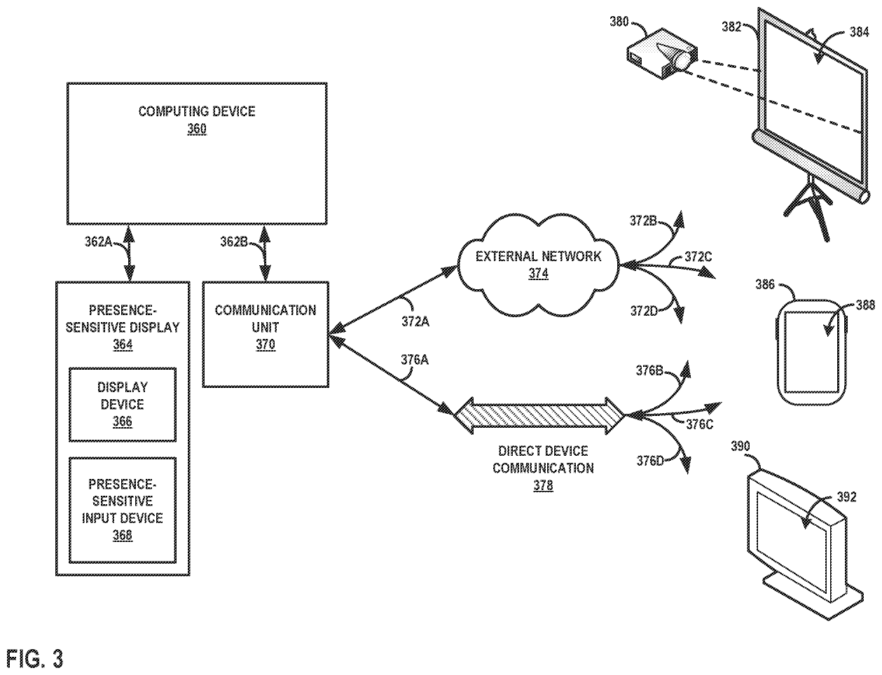

FIG. 3 is a block diagram illustrating an example computing device that outputs graphical content for display at a remote device, in accordance with one or more techniques of the present disclosure. Graphical content, generally, may include any visual information that may be output for display, such as text, images, a group of moving images, to name only a few examples. The example shown in FIG. 3 includes a computing device 360, a presence-sensitive display 364, communication unit 370, projector 380, projector screen 382, mobile device 386, and visual display device 390. In some examples, presence-sensitive display 364 may be an example of display 114 shown in FIG. 1 and display 214 shown in FIG. 2. Although shown for purposes of example in FIGS. 1 and 2 as a stand-alone computing device 102 and stand-alone computing device 202, a computing device such as computing device 360 may, generally, be any component or system that includes a processor or other suitable computing environment for executing software instructions and, for example, need not include a presence-sensitive display.

As shown in the example of FIG. 3, computing device 360 may be an example of computing device 102 of FIG. 1 or computing device 202 of FIG. 2, and may include a processor that includes functionality as described with respect to one or more processors 108 of FIG. 1 or one or more processors 240 of FIG. 2. In such examples, computing device 360 may be operatively coupled to presence-sensitive display 364 by a communication channel 362A, which may be a system bus or other suitable connection. Computing device 360 may also be operatively coupled to communication unit 370, further described below, by a communication channel 362B, which may also be a system bus or other suitable connection. Although shown separately as an example in FIG. 3, computing device 360 may be operatively coupled to presence-sensitive display 364 and communication unit 370 by any number of one or more communication channels.

In other examples, such as illustrated previously by computing device 102 of FIG. 1 and computing device 202 of FIG. 2, a computing device may refer to a portable or mobile device such as mobile phones (including smart phones), laptop computers, wearable device, etc. In some examples, a computing device may be a desktop computer, tablet computer, smart television platform, camera, server, or mainframes.

Presence-sensitive display 364 may include display device 366 and presence-sensitive input device 368. Display device 366 may, for example, receive data from computing device 360 and display the graphical content. In some examples, presence-sensitive input device 368 may determine one or more user inputs (e.g., continuous gestures, multi-touch gestures, single-touch gestures) at presence-sensitive display 364 using capacitive, inductive, and/or optical recognition techniques and send indications of such user input to computing device 360 using communication channel 362A. In some examples, presence-sensitive input device 368 may be physically positioned on top of display device 366 such that, when a user positions an input unit over a graphical element displayed by display device 366, the location at which presence-sensitive input device 368 corresponds to the location of display device 366 at which the graphical element is displayed.

As shown in FIG. 3, computing device 360 may also include and/or be operatively coupled with communication unit 370. Communication unit 370 may include functionality of communication unit 244 as described in FIG. 2. Examples of communication unit 370 may include a network interface card, an Ethernet card, an optical transceiver, a radio frequency transceiver, or any other type of device that can send and receive information. Other examples of such communication units may include Bluetooth, 3G, and WiFi radios, Universal Serial Bus (USB) interfaces, etc. Computing device 360 may also include and/or be operatively coupled with one or more other devices (e.g., input devices, output devices, memory, storage devices) that are not shown in FIG. 3 for purposes of brevity and illustration.

FIG. 3 also illustrates a projector 380 and projector screen 382. Other such examples of projection devices may include electronic whiteboards, holographic display devices, and any other suitable devices for displaying graphical content. Projector 380 and projector screen 382 may include one or more communication units that enable the respective devices to communicate with computing device 360. In some examples, the one or more communication units may enable communication between projector 380 and projector screen 382. Projector 380 may receive data from computing device 360 that includes graphical content. Projector 380, in response to receiving the data, may project the graphical content onto projector screen 382. In some examples, projector 380 may determine one or more user inputs (e.g., continuous gestures, multi-touch gestures, single-touch gestures) at projector screen using optical recognition or other suitable techniques and send indications of such user input using one or more communication units to computing device 360. In such examples, projector screen 382 may be unnecessary, and projector 380 may project graphical content on any suitable medium and detect one or more user inputs using optical recognition or other such suitable techniques.

Projector screen 382, in some examples, may include a presence-sensitive display 384. Presence-sensitive display 384 may include a subset of functionality or all of the functionality of presence-sensitive display 384 and/or 364 as described in this disclosure. In some examples, presence-sensitive display 384 may include additional functionality. Projector screen 382 (e.g., an electronic whiteboard), may receive data from computing device 360 and display the graphical content. In some examples, presence-sensitive display 384 may determine one or more user inputs (e.g., continuous gestures, multi-touch gestures, single-touch gestures) at projector screen 382 using capacitive, inductive, and/or optical recognition techniques and send indications of such user input using one or more communication units to computing device 360.

FIG. 3 also illustrates mobile device 386 and visual display device 390. Mobile device 386 and visual display device 390 may each include computing and connectivity capabilities. Examples of mobile device 386 may include e-reader devices, convertible notebook devices, hybrid slate devices, etc. Examples of visual display device 390 may include other semi-stationary devices such as televisions, computer monitors, etc. As shown in FIG. 3, mobile device 386 may include a presence-sensitive display 388. Visual display device 390 may include a presence-sensitive display 392. Presence-sensitive displays 388 and 392 may include a subset of functionality or all of the functionality of presence-sensitive display 384 and/or 364 as described in this disclosure. In some examples, presence-sensitive displays 388 and 392 may include additional functionality. In any case, presence-sensitive display 392, for example, may receive data from computing device 360 and display the graphical content. In some examples, presence-sensitive display 392 may determine one or more user inputs (e.g., continuous gestures, multi-touch gestures, single-touch gestures) at projector screen using capacitive, inductive, and/or optical recognition techniques and send indications of such user input using one or more communication units to computing device 360.

As described above, in some examples, computing device 360 may output graphical content for display at presence-sensitive display 364 that is coupled to computing device 360 by a system bus or other suitable communication channel. Computing device 360 may also output graphical content for display at one or more remote devices, such as projector 380, projector screen 382, mobile device 386, and visual display device 390. For instance, computing device 360 may execute one or more instructions to generate and/or modify graphical content in accordance with techniques of the present disclosure. Computing device 360 may output the data that includes the graphical content to a communication unit of computing device 360, such as communication unit 370. Communication unit 370 may send the data to one or more of the remote devices, such as projector 380, projector screen 382, mobile device 386, and/or visual display device 390. In this way, computing device 360 may output the graphical content for display at one or more of the remote devices. In some examples, one or more of the remote devices may output the graphical content at a presence-sensitive display that is included in and/or operatively coupled to the respective remote devices.

In some examples, computing device 360 may not output graphical content at presence-sensitive display 364 that is operatively coupled to computing device 360. In other examples, computing device 360 may output graphical content for display at both a presence-sensitive display 364 that is coupled to computing device 360 by communication channel 362A, and at one or more remote devices. In such examples, the graphical content may be displayed substantially contemporaneously at each respective device. For instance, some delay may be introduced by the communication latency to send the data that includes the graphical content to the remote device. In some examples, graphical content generated by computing device 360 and output for display at presence-sensitive display 364 may be different than graphical content display output for display at one or more remote devices.

Computing device 360 may send and receive data using any suitable communication techniques. For example, computing device 360 may be operatively coupled to external network 374 using network link 372A. Each of the remote devices illustrated in FIG. 3 may be operatively coupled to external network 374 by one of respective network links 372B, 372C, or 372D. External network 374 may include network hubs, network switches, network routers, etc., that are operatively inter-coupled thereby providing for the exchange of information between computing device 360 and the remote devices illustrated in FIG. 3. In some examples, network links 372A-372D may be Ethernet, ATM or other network connections. Such connections may be wireless and/or wired connections.

In some examples, computing device 360 may be operatively coupled to one or more of the remote devices included in FIG. 3 using direct device communication 378. Direct device communication 378 may include communications through which computing device 360 sends and receives data directly with a remote device, using wired or wireless communication. That is, in some examples of direct device communication 378, data sent by computing device 360 may not be forwarded by one or more additional devices before being received at the remote device, and vice-versa. Examples of direct device communication 378 may include Bluetooth, Near-Field Communication, Universal Serial Bus, WiFi, infrared, etc. One or more of the remote devices illustrated in FIG. 3 may be operatively coupled with computing device 360 by communication links 376A-376D. In some examples, communication links 376A-376D may be connections using Bluetooth, Near-Field Communication, Universal Serial Bus, infrared, etc. Such connections may be wireless and/or wired connections.

In accordance with techniques of the disclosure, a gaming application may execute at computing device 360 and may output image data for display at presence-sensitive display 364, presence-sensitive display 384, presence-sensitive display 388, or presence-sensitive display 392. Computing device 360 may determine, based at least in part on one or more characteristics associated with the gaming application executing at computing device 360, whether the gaming application is in a loading state. Computing device 360 may, in response to determining that the gaming application is in the loading state, adjust at least one of: a clock speed of the one or more processors of computing device 360 or a prioritization of the gaming application to enable the gaming application to more quickly transition from the loading state to another state, such as to the gaming state.

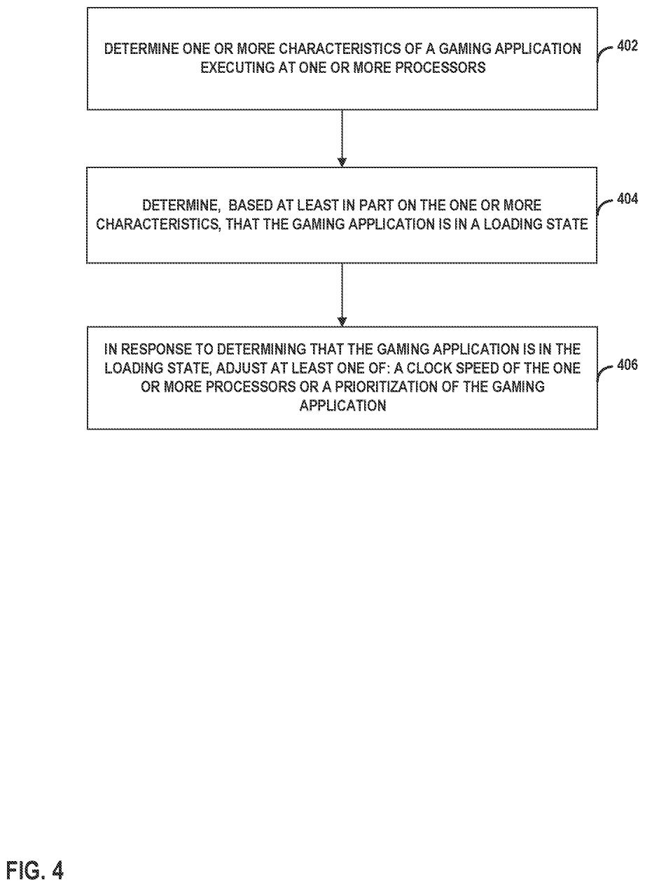

FIG. 4 is a flowchart illustrating an example mode of operation for a computing device to determine whether a gaming application is in a loading state, in accordance with one or more techniques of the present disclosure. FIG. 4 is described below in the context of computing device 202 of FIG. 2. As shown in FIG. 4, computing device 202 may determine one or more characteristics of a gaming application 212 executing at one or more processors 240 of the computing device 202 (402). The computing device 202 may determine that the gaming application 212 executing at the one or more processors 240 is in a loading state based at least in part on the one or more characteristics (404). The computing device 202 may, in response to determining that the gaming application 212 is in the loading state, adjust at least one of: a clock speed of the one or more processors 240 or a prioritization of the gaming application 212 (406).

This disclosure includes the following examples.

Example 1: A method includes determining, by one or more processors of a computing device, one or more characteristics of a gaming application executing at the one or more processors; determining, by the one or more processors, that the gaming application is in a loading state; and in response to determining that the gaming application is in the loading state, adjusting, by the one or more processors, at least one of: a clock speed of the one or more processors or a prioritization of the gaming application.

Example 2: The method of example 1, wherein the one or more characteristics comprise patterns of usage of the one or more processors by the gaming application during execution at the one or more processors, wherein determining that the gaming application is in the loading state further comprises: determining, by the one or more processors and based at least in part on the patterns of usage of the one or more processors by the gaming application, that the gaming application is in the loading state.

Example 3: The method of any one of examples 1 and 2, wherein the one or more characteristics comprise a pattern of functions invoked by the gaming application during execution at the one or more processors, and wherein determining that the gaming application is in the loading state further comprises: determining, by the one or more processors and based at least in part on a pattern of functions invoked by the gaming application, that the gaming application is in the loading state.

Example 4: The method of any one of examples 1-4, wherein the one or more characteristics comprise a pattern of inputs received at an input device during execution of the gaming application at the one or more processors, and wherein determining that the gaming application is in the loading state further comprises: determining, by the one or more processors and based at least in part on the pattern of inputs received at an input device, that the gaming application is in the loading state.

Example 5: The method of any one of examples 1-4, wherein the one or more characteristics comprise image data outputted for display at a display device by the gaming application, and wherein determining that the gaming application is in the loading state further comprises: determining, by the one or more processors and based at least in part on the image data outputted for display at the display device, that the gaming application is in the loading state.

Example 6: The method of any one of examples 1-5, wherein determining that the gaming application is in the loading state further comprises: determining, by the one or more processors, that the gaming application is performing one or more action to prepare to provide an interactive gameplay environment for active gameplay.

Example 7: The method of any of examples 1-6, wherein adjusting at least one of: the clock speed of the one or more processors or the prioritization of the gaming application further comprises: adjusting, by the one or more processors, a respective clock speed of at least one of: a central processing unit (CPU) or a graphics processing unit (GPU) of the one or more processors.

Example 8: The method of example 7, wherein adjusting the respective clock speed of at least one of: the CPU or the GPU of the one or more processors further comprises: adjusting, by the one or more processors, the respective clock speed of at least one of: the CPU or the GPU of the one or more processors above a clock speed threshold associated with the computing device running on battery power.

Example 9: The method of example 7, wherein adjusting the respective clock speed of at least one of: the CPU or the GPU of the one or more processors further comprises: adjusting, by the one or more processors, the respective clock speed of at least one of: the CPU or the GPU of the one or more processors based at least in part on functions invoked by the gaming application in the loading state.

Example 10: The method of example 7, wherein adjusting the respective clock speed of at least one of: the CPU or the GPU of the one or more processors further comprises: looking up, by the one or more processors, at least one of: a loading state CPU clock speed associated with the gaming application or a loading state GPU clock speed associated with the gaming application; and adjusting, by the one or more processors, the respective clock speed of at least one of: the CPU or the GPU of the one or more processors based at least in part on at least one of: the loading state CPU clock speed or the loading state GPU clock speed.

Example 11: A computing device includes memory; and one or more processors operably coupled to the memory and configured to: determine one or more characteristics of a gaming application executing at the one or more processors; determine that the gaming application is in a loading state based at least in part on the one or more characteristics; and in response to determining that the gaming application is in the loading state, adjust at least one of: a clock speed of the one or more processors or a prioritization of the gaming application.

Example 12: The computing device of example 11, wherein the one or more characteristics comprise one or more of: patterns of usage of the one or more processors by the gaming application during execution at the one or more processors, a pattern of functions invoked by the gaming application during execution at the one or more processors, a pattern of inputs received at an input device during execution of the gaming application at the one or more processors, or image data outputted for display at the display device by the gaming application, and wherein to determine that the gaming application is in the loading state, the one or more processors are further configured to: determine, and based at least in part on one or more of: the patterns of usage of the one or more processors by the gaming application, pattern of functions invoked by the gaming application during execution at the one or more processors, the pattern of inputs received at an input device during execution of the gaming application at the one or more processors, or the image data outputted for display at the display device by the gaming application, that the gaming application is in the loading state.

Example 13: The computing device of any one of examples 11 and 12, wherein to determine that the gaming application is in the loading state, the one or more processors are further configured to: determine that the gaming application is performing one or more action to prepare to provide an interactive gameplay environment for active gameplay.

Example 14: The computing device of any one of examples 11-13, wherein to adjust at least one of: the clock speed of the one or more processors or the prioritization of the gaming application, the one or more processors are further configured to: adjust a respective clock speed of at least one of: a central processing unit (CPU) or a graphics processing unit (GPU) of the one or more processors.

Example 15: The computing device of example 14, wherein to adjust the respective clock speed of at least one of: the CPU or the GPU of the one or more processors, the one or more processors are further configured to: adjust the respective clock speed of at least one of: the CPU or the GPU of the one or more processors based at least in part on functions invoked by the gaming application in the loading state.

Example 16: The computing device of example 14, wherein to adjust the respective clock speed of at least one of: the CPU or the GPU of the one or more processors, the one or more processors are further configured to: adjust the respective clock speed of at least one of: the CPU or the GPU of the one or more processors based at least in part on functions invoked by the gaming application in the loading state.

Example 17: The computing device of example 14, wherein to adjust the respective clock speed of at least one of: the CPU or the GPU of the one or more processors, the one or more processors are further configured to: look up at least one of: a loading state CPU clock speed associated with the gaming application or a loading state GPU clock speed associated with the gaming application; and adjust the respective clock speed of at least one of: the CPU or the GPU of the one or more processors based at least in part on at least one of: the loading state CPU clock speed or the loading state GPU clock speed.

Example 18: A computer-readable storage medium storing instructions that, when executed, cause one or more processors of a computing device to performing any one of the methods of example 1-10.

Example 19: A computing device comprising means for performing the methods of any one of examples 1-10.

Example 20: A computer-readable storage medium encoded with instructions that cause one or more processors of a computing device to perform the methods of any one of examples 1-10.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various embodiments have been described. These and other embodiments are within the scope of the following claims.

1-18. (canceled)

19. A method comprising:
determining, by one or more processors of a computing device, one or more characteristics of a gaming application executing at the one or more processors;
determining, by the one or more processors and based at least in part on the one or more characteristics, that the gaming application is in a loading state; and
in response to determining that the gaming application is in the loading state, adjusting, by the one or more processors, at least one of: a clock speed of the one or more processors or a prioritization of the gaming application.

20. The method of claim 19, wherein the one or more characteristics comprise patterns of usage of the one or more processors by the gaming application during execution at the one or more processors, and wherein determining that the gaming application is in the loading state further comprises:
determining, by the one or more processors and based at least in part on the patterns of usage of the one or more processors by the gaming application, that the gaming application is in the loading state.

21. The method of claim 19, wherein the one or more characteristics comprise a pattern of functions invoked by the gaming application during execution at the one or more processors, and wherein determining that the gaming application is in the loading state further comprises:
determining, by the one or more processors and based at least in part on a pattern of functions invoked by the gaming application, that the gaming application is in the loading state.

22. The method of claim 19, wherein the one or more characteristics comprise a pattern of inputs received at an input device during execution of the gaming application at the one or more processors, and wherein determining that the gaming application is in the loading state further comprises:
determining, by the one or more processors and based at least in part on the pattern of inputs received at an input device, that the gaming application is in the loading state.

23. The method of claim 19, wherein the one or more characteristics comprise image data outputted for display at a display device by the gaming application, and wherein determining that the gaming application is in the loading state further comprises:
determining, by the one or more processors and based at least in part on the image data outputted for display at the display device, that the gaming application is in the loading state.

24. The method of claim 19, wherein determining that the gaming application is in the loading state further comprises:
determining, by the one or more processors, that the gaming application is performing one or more actions to prepare to provide an interactive gameplay environment for active gameplay.

25. The method of claim 19, wherein adjusting at least one of: the clock speed of the one or more processors or the prioritization of the gaming application further comprises:
adjusting, by the one or more processors, a respective clock speed of at least one of: a central processing unit (CPU) or a graphics processing unit (GPU) of the one or more processors.

26. The method of claim 25, wherein adjusting the respective clock speed of at least one of: the CPU or the GPU of the one or more processors further comprises:
adjusting, by the one or more processors, the respective clock speed of at least one of: the CPU or the GPU of the one or more processors above a clock speed threshold associated with the computing device running on battery power.

27. The method of claim 25, wherein adjusting the respective clock speed of at least one of: the CPU or the GPU of the one or more processors further comprises:
adjusting, by the one or more processors, the respective clock speed of at least one of: the CPU or the GPU of the one or more processors based at least in part on functions invoked by the gaming application in the loading state.

28. The method of claim 25, wherein adjusting the respective clock speed of at least one of: the CPU or the GPU of the one or more processors further comprises:
looking up, by the one or more processors, at least one of: a loading state CPU clock speed associated with the gaming application or a loading state GPU clock speed associated with the gaming application; and
adjusting, by the one or more processors, the respective clock speed of at least one of: the CPU or the GPU of the one or more processors based at least in part on at least one of: the loading state CPU clock speed or the loading state GPU clock speed.

29. A computing device comprising:
memory; and
one or more processors operably coupled to the memory and configured to:
determine one or more characteristics of a gaming application executing at the one or more processors;
determine that the gaming application is in a loading state based at least in part on the one or more characteristics; and
in response to determining that the gaming application is in the loading state, adjust at least one of: a clock speed of the one or more processors or a prioritization of the gaming application.

30. The computing device of claim 29, further comprising:
a display device,
wherein the one or more characteristics comprise one or more of: patterns of usage of the one or more processors by the gaming application during execution at the one or more processors, a pattern of functions invoked by the gaming application during execution at the one or more processors, a pattern of inputs received at an input device during execution of the gaming application at the one or more processors, or image data outputted for display at the display device by the gaming application, and wherein to determine that the gaming application is in the loading state, the one or more processors are further configured to:
determine, and based at least in part on one or more of: the patterns of usage of the one or more processors by the gaming application, pattern of functions invoked by the gaming application during execution at the one or more processors, the pattern of inputs received at an input device during execution of the gaming application at the one or more processors, or the image data outputted for display at the display device by the gaming application, that the gaming application is in the loading state.

31. The computing device of claim 29, wherein to determine that the gaming application is in the loading state, the one or more processors are further configured to:
determine that the gaming application is performing one or more action to prepare to provide an interactive gameplay environment for active gameplay.

32. The computing device of claim 29, wherein to adjust at least one of: the clock speed of the one or more processors or the prioritization of the gaming application, the one or more processors are further configured to:
adjust a respective clock speed of at least one of: a central processing unit (CPU) or a graphics processing unit (GPU) of the one or more processors.

33. The computing device of claim 32, wherein to adjust the respective clock speed of at least one of: the CPU or the GPU of the one or more processors, the one or more processors are further configured to:
adjust the respective clock speed of at least one of: the CPU or the GPU of the one or more processors above a clock speed threshold associated with the computing device running on battery power.

34. The computing device of claim 32, wherein to adjust the respective clock speed of at least one of: the CPU or the GPU of the one or more processors, the one or more processors are further configured to:
adjust the respective clock speed of at least one of: the CPU or the GPU of the one or more processors based at least in part on functions invoked by the gaming application in the loading state.

35. The computing device of claim 32, wherein to adjust the respective clock speed of at least one of: the CPU or the GPU of the one or more processors, the one or more processors are further configured to:
look up at least one of: a loading state CPU clock speed associated with the gaming application or a loading state GPU clock speed associated with the gaming application; and
adjust the respective clock speed of at least one of: the CPU or the GPU of the one or more processors based at least in part on at least one of: the loading state CPU clock speed or the loading state GPU clock speed.

36. A computer-readable storage medium storing instructions that, when executed, cause one or more processors of a computing device to:
determine one or more characteristics of a gaming application executing at the one or more processors;
determine that the gaming application is in a loading state based at least in part on the one or more characteristics; and
in response to determining that the gaming application is in the loading state, adjust at least one of: a clock speed of the one or more processors or a prioritization of the gaming application.

37. The computer-readable storage medium of claim 36, wherein the one or more characteristics comprise one or more of: patterns of usage of the one or more processors by the gaming application during execution at the one or more processors, a pattern of functions invoked by the gaming application during execution at the one or more processors, a pattern of inputs received at an input device during execution of the gaming application at the one or more processors, or image data outputted for display at a display device by the gaming application, and wherein to determine that the gaming application is in the loading state, the instructions further cause the one or more processors to:
determine, and based at least in part on one or more of: the patterns of usage of the one or more processors by the gaming application, pattern of functions invoked by the gaming application during execution at the one or more processors, the pattern of inputs received at an input device during execution of the gaming application at the one or more processors, or the image data outputted for display at a display device by the gaming application, that the gaming application is in the loading state.

38. The computer-readable storage medium of claim 36, wherein to adjust at least one of: the clock speed of the one or more processors or the prioritization of the gaming application, the instructions further cause the one or more processors to:
adjust a respective clock speed of at least one of: a central processing unit (CPU) or a graphics processing unit (GPU) of the one or more processors.
